(19) United States
(12) Patent Application Publication
(10) Pub. No.: US 2018/0048216 A1
(43) Pub. Date: Feb. 15, 2018

(54) MOTOR

(71) Applicant: TOYOTA JIDOSHA KABUSHIKI KAISHA, Toyota-shi (JP)

(72) Inventor: Kiyoharu NAKAMURA, Seto-shi (JP)

(73) Assignee: TOYOTA JIDOSHA KABUSHIKI KAISHA, Toyota-shi (JP)

(21) Appl. No.: 15/673,746

(22) Filed: Aug. 10, 2017

(30) Foreign Application Priority Data
Aug. 15, 2016 (JP) 2016-159218

(51) Int. Cl. H02K 9/19; H02K 1/27; H02K 1/14

(52) U.S. Cl. CPC H02K 9/19; H02K 1/146; H02K 1/2733; H02K 2201/03

(57) ABSTRACT

A motor according to as aspect of the present invention includes a cylindrical rotor and a stator disposed so as to surround an outer peripheral surface of the rotor. The stator includes a stator core including a plurality of teeth radially arranged about a rotation axis of the rotor; and a stator coil inserted between each adjacent pair of the teeth. A flow channel for supplying a coolant to the outer peripheral surface of the rotor is formed within the teeth, and a projection part is provided at a tip face of each of the teeth facing the outer peripheral surface of the rotor in such a manner that an interval between the tip face of each of the teeth and the outer peripheral surface of the rotor gradually decreases in a rotation direction of the rotor.

### CROSS REFERENCE TO RELATED APPLICATIONS

This application is based upon and claims the benefit of priority from Japanese patent application No. 2016-159218, filed on Aug. 15, 2016, the disclosure of which is incorporated herein in its entirety by reference.

### BACKGROUND

In recent years, there has been a demand for increasing the rotational speed of a motor. However, an increase in the rotational speed of a motor results in generation of an eddy current which generates heat in the motor. Accordingly, the motor is generally cooled by a cooling mechanism.

For example, a motor disclosed in Japanese Unexamined Patent Application Publication No. 2014-23387 has a structure in which a groove extending in the axial direction of a rotor is formed in a resin mold for fixing a coil that is inserted into a slot of the stator and oil is caused to flow through the groove to thereby cool the stator.

In the motor, not only the stator, but also the rotor may generate heat. Although the motor disclosed in Japanese Unexamined Patent Application Publication No. 2014-23387 can cool the stator, it is difficult to suitably supply oil to the rotor, which may make it difficult to sufficiently cool the rotor.

Even if the motor has a structure in which the rotor can be supplied with oil, an air between the rotor and the stator is caused to flow along the circumferential direction of the rotor due to the rotation of the rotor. As a result, the oil is scattered due to the flow of the air, which makes it difficult to suitably supply oil to the rotor. After all, it may be difficult to sufficiently cool the rotor.

### SUMMARY

The present invention has been made in view of the above-mentioned problems and realizes a motor having an excellent capability of cooling a rotor.

A motor according to an aspect includes: a rotor having a cylindrical shape; and a stator disposed so as to surround an outer peripheral surface of the rotor. The stator includes: a stator core including a plurality of teeth radially arranged about a rotation axis of the rotor; and a stator coil inserted between each adjacent pair of the teeth. A flow channel for supplying a coolant to the outer peripheral surface of the rotor is formed within the teeth. A projection part is provided at a tip face of each of the teeth facing the outer peripheral surface of the rotor in such a manner that an interval between the tip face of each of the teeth and the outer peripheral surface of the rotor gradually decreases in a rotation direction of the rotor.

With this structure, a radial component of the rotor is generated in the flow of the air between the rotor and the stator, so that the coolant supplied between the rotor and the stator can be suitably supplied to the rotor. Therefore, the motor has an excellent capability of cooling a rotor.

In the motor described above, the projection part is preferably formed of a non-magnetic material.

With this structure, magnetic properties of the stator are not changed and thus have no adverse effect on the characteristics of the motor.

In the motor described above, the projection part preferably includes an inclined part that gradually is inclined toward the outer peripheral surface of the rotor in a rotation direction of the rotor.

With this structure, the radial component of the rotor is suitably generated in the flow of the air between the rotor and the stator, and an air resistance caused when the rotor is rotated can be suppressed.

In the motor described above, the motor is preferably a motor of a compressor for a fuel cell.

Since the motor of the compressor for the fuel cell has a high rotational speed, an eddy current is generated and the motor is more likely to generate heat. Therefore, the above-mentioned motor is suitably used.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a sectional view schematically showing a motor according to an embodiment;

FIG. 2 is a perspective view schematically showing a rotor in the motor of the embodiment and a stator mounted with a stator coil;

FIG. 3 is a perspective view schematically showing the rotor in the motor of the embodiment and the stator in which the illustration of the stator coil is omitted;

FIG. 4 is a plan view schematically showing a stator core of the stator in the motor of the embodiment;

FIG. 5 is a diagram schematically showing a first steel plate of the stator in the motor of the embodiment;

FIG. 6 is a diagram schematically showing a second steel plate of the stator in the motor of the embodiment;

FIG. 7 is an enlarged view of a part facing the rotor of the stator in the motor of the embodiment; and

FIG. 8 is a diagram for explaining a preferable slope of an inclined part at a projection part.

### DESCRIPTION OF EMBODIMENTS

Specific embodiments of the present invention will be described in detail below with reference to the drawings. However, the present invention is not limited to the following embodiments. For clarity of explanation, the following description and the drawings are simplified as appropriate.

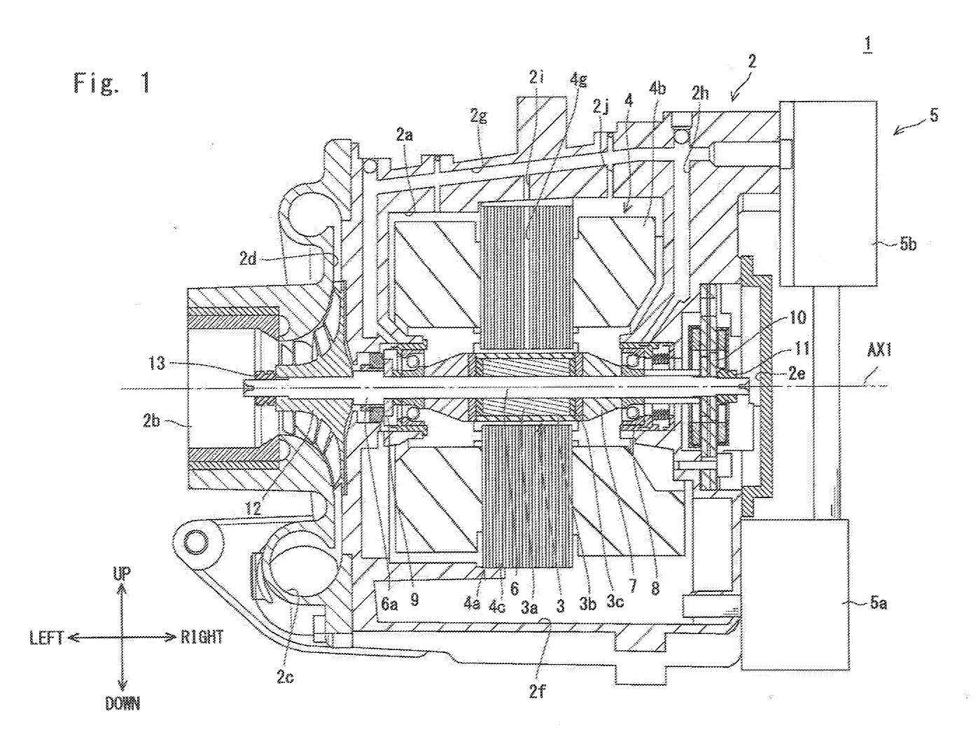

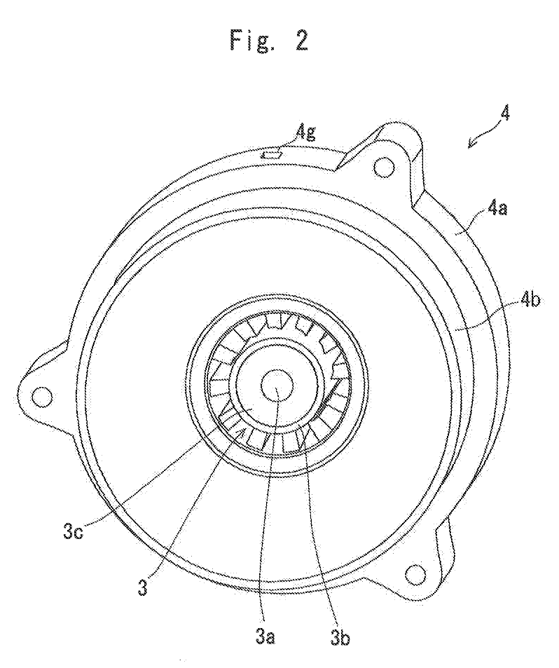

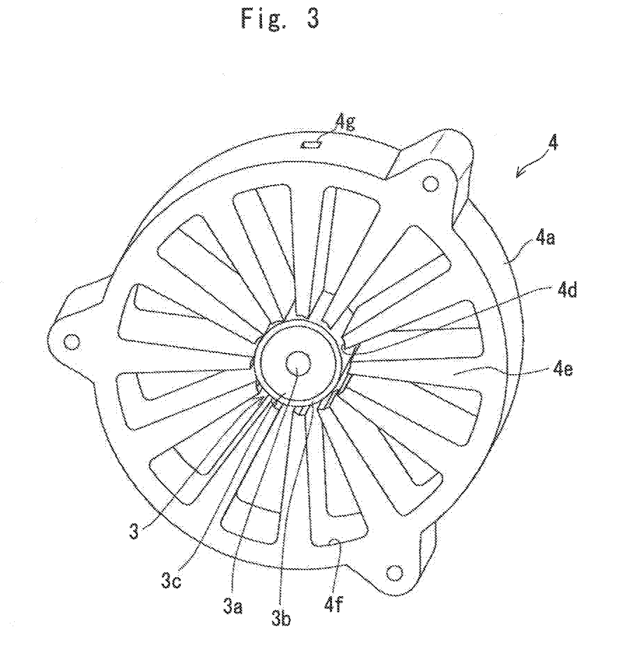

FIG. 1 is a sectional view schematically showing a motor according to this embodiment. FIG. 2 is a perspective view schematically showing a rotor in the motor of this embodiment and a stator mounted with a stator coil. FIG. 3 is a perspective view schematically showing the rotor in the motor of this embodiment and the stator in which the illustration of the stator coil is omitted.

Note that in FIG. 2, the illustration of the stator coil of the stator is simplified. In FIGS. 2 and 3, the illustration of stacked steel plates of the stator is simplified. In the following description, for clarity of explanation, an up-and-down direction and a right-and-left direction of the motor are defined as shown in FIG. 1. Note that in a normal use mode of the motor, the up-and-down direction of the motor coincides with the vertical direction, and the right-and-left direction of the motor coincides with the horizontal direction. However, these directions may be changed as appropriate depending on the use mode of the motor.

A motor 1 of this embodiment is suitably used as a motor of a compressor for a fuel cell (FC). As shown in FIG. 1, the motor 1 includes a housing 2, a rotor 3, a stator 4, and a cooling mechanism 5. Although the motor 1 of this embodiment is structured as a motor of a compressor for FC, the motor 1 can also be implemented by other types of motors.

The housing 2 includes a first accommodating part 2a that accommodates the rotor 3 and the stator 4, an air intake port 2b, an exhaust port 2c through which an air supplied from the intake port 2b is exhausted, and a first flow channel 2d that communicates the intake port 2b with the exhaust port 2c.

As shown in FIGS. 1 to 3, the rotor 3 has a cylindrical shape as a basic form, and includes a magnet 3a, a cylinder 3b, and end plates 3c. The magnet 3a is formed into a cylindrical shape in which a penetrating part extends in the right-and-left direction of the rotor 3. The cylinder 3h is formed into a cylindrical shape in which a penetrating part extends in the right-and-left direction of the rotor 3, and the magnet 3a is press-fit into the penetrating part of the cylinder 3b in such a manner that a compressive stress is imparted to the magnet 3a. Each end plate 3c includes a penetrating part which has an inside diameter substantially equal to that of the penetrating part of the magnet 3a and is fit into the penetrating part of the cylinder 3b in such a manner that the magnet 3a is sandwiched between the end plates 3c in the right-and-left direction of the magnet 3a.

As shown in FIG. 1, a rotating shaft 6 extending in the right-and-left direction of the motor 1 is press-fit into the penetrating parts of the penetrating magnet 3a of the rotor 3 and the end plates 3c. Further, the rotor 3 is rotatably supported by the housing 2 through the rotating shaft 6 in a state where the rotor 3 is accommodated in the first accommodating part 2a of the housing 2.

In this embodiment, spacers 7, bearings 8, and sealants 9 are provided on the rotating shaft 6 in such a manner that the rotor 3 is sandwiched in the right-and-left direction of the motor 1, and the rotating shaft 6 is rotatably supported by the housing 2 through the bearings 8 and the sealants 9. With this structure, the rotator 3 can he rotatably supported by the housing 2 through the rotating shaft 6.

A right-side part of the rotating shaft 6 is provided with a resolver 10 for detecting a rotation angle of the rotor 3. An axial force of a nut 11 that is screwed into a right end part of the rotating shaft 6 allows the rotor 3, the right and left spacers 7, the right and left hearings 8, the sealants 9, and the resolver 10 to be fastened between the nut 11 and a flange part 6a that is formed on the rotating shaft 6, thereby allowing the rotor 3 and the rotating shaft 6 to be rotatably supported. In this embodiment, the resolver 10 is accommodated in the second accommodating part 2e that is formed in the housing 2, but the arrangement of the resolver 10 is not particularly limited.

A left-side part (a part on the left side of the flange part 6a of the rotating shaft 6) of the rotating shaft 6 projects toward the first flow channel 2d of the housing 2. A turbine 12 that is disposed in the first flow channel 2d of the housing 2 passes through the left-side part of the rotating shaft 6, and a nut 13 is screwed into the left-side part of the rotating shaft 6 in such a manner that the turbine 12 is fixed between the nut 13 and the flange part 6a of the rotating shaft 6. Accordingly, when the rotating shaft 6 is rotated, the air sucked from the intake port 2b of the housing 2 is compressed by the turbine 12 and exhausted from the exhaust port 2c of the housing 2, and is then supplied to, for example, the FC stack.

As shown in FIGS. 2 and 3, the stator 4 is disposed so as to surround the rotor 3 and is fixed to the housing 2 in a state where the stator 4 is accommodated in the first accommodating part 2a of the housing 2.

As shown in FIG. 2, the stator 4 includes a stator core 4a and a stator coil 4b. As shown in FIGS. 1 and 3, the stator core 4a is composed of a plurality of stacked steel plates 4c, and includes inserted parts 4d, teeth 4e, and slots 4f. Note that the detailed shape of each steel plate 4c is described later.

As shown in FIG. 3, each inserted part 4d is formed to so as to penetrate in the right-and-left direction of the stator 4 through a substantially central part of the stator 4 and the rotor 3 is inserted into the inserted part 4d. The teeth 4e are radially arranged about a rotation axis AX1 (FIG. 1) of the rotor 3 and each slot 4f is formed between each adjacent pair of the teeth 4e. The stator coil 4b is inserted into each slot 4f in such a manner that the stator coil 4b is wound around predetermined teeth 4e, and the stator coil 4b is resin-molded. However, the stator coil 4b need not necessarily be resin-molded. There is no need to wind the stator coil 4b around the teeth, as long as the stator coil 4b is mounted on the stator core 4a.

The cooling mechanism 5 cools the rotor 3 and the stator 4. As shown in FIG. 1, the cooling mechanism 5 of this embodiment includes a pump 5a and a cooler 5b. The pump 5a delivers the coolant accumulated in a receiving part 2f, which is formed below the first accommodating part 2a of the housing 2, to the cooler 5b.

Oil such as automatic transmission fluid (ATF) which is generally used for lubricating the bearings 8 is suitably used as the coolant.

The cooler 5b cools the coolant delivered from the pump 5a and supplies the coolant to a second flow channel 2g that is formed in the housing 2. The second flow channel 2g is connected to each of a third flow channel 2h that guides the coolant to the bearings 8, a fourth flow channel 2i that guides the coolant to the stator core 4a of the stator 4, and a fifth flow channel 2j that guides the coolant to the stator coil 4b of the stator 4.

With this structure, the coolant supplied to the second flow channel 2g is supplied (e.g., by dropping) to the bearings 8 through the third flow channel 2h. Further, the coolant supplied to the second flow channel 2g is supplied (e.g., by dropping) to the stator core 4a of the stator 4 through the fourth flow channel 2i. Furthermore, the coolant supplied to the second flow channel 2g is supplied (e.g., by dropping) to the stator coil 4b of the stator 4 through the fifth flow channel 2j.

As a result, the bearings 8 and the stator core 4a and the stator coil 4b of the stator 4 can be cooled. Incidentally, the supplied coolant is collected into the receiving part 2f of the housing 2 and is delivered to the cooler 5b again by the pump 5a.

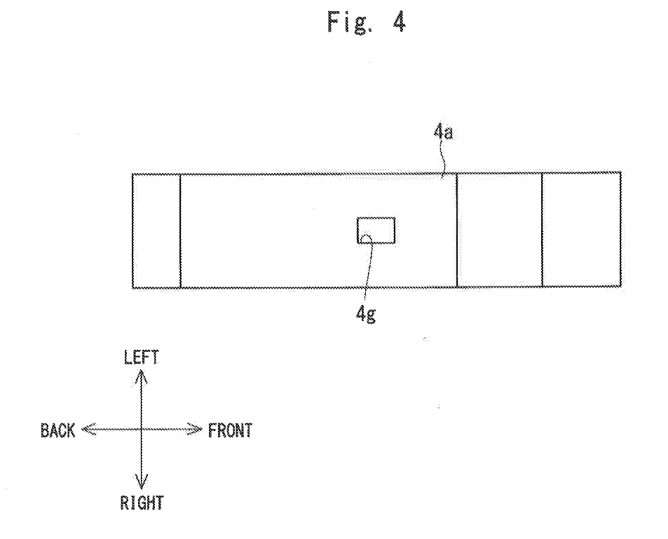

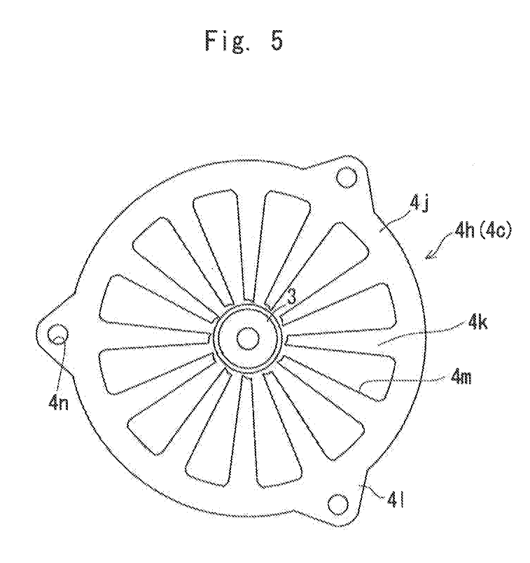

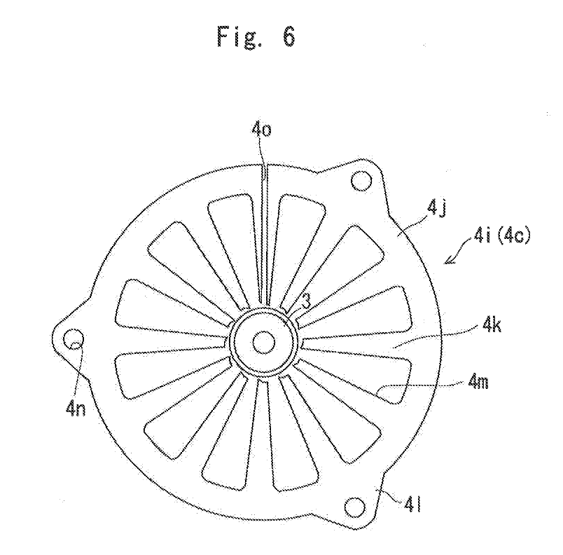

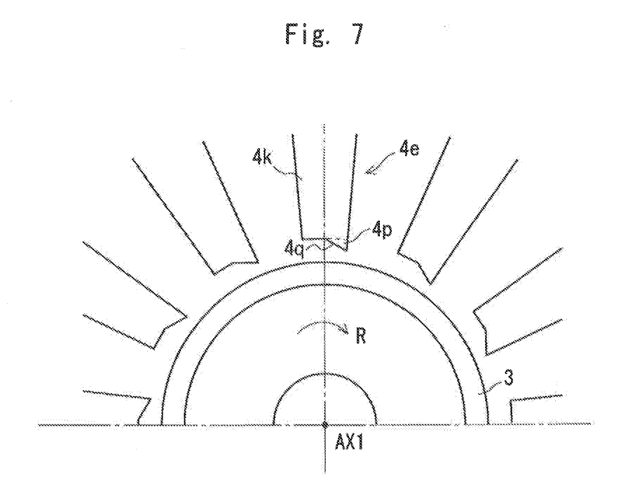

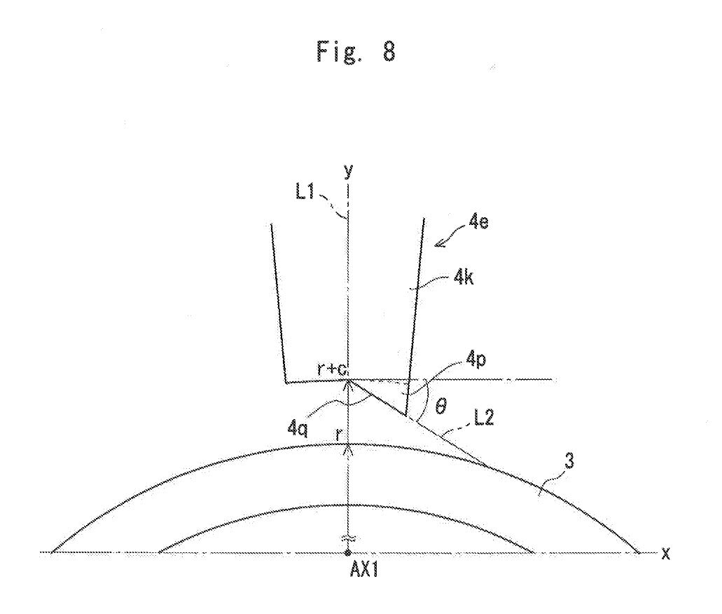

In this case, the motor 1 of this embodiment has an excellent capability of cooling not only the stator 4, but also the rotor 3, and is capable of supplying a coolant to the rotor 3 through the stator 4. FIG. 4 is a plan view schematically showing the stator core of the rotor in the motor of this embodiment. FIG. 5 is a diagram schematically showing a first steel plate of the stator in the motor of this embodiment. FIG. 6 is a diagram schematically showing a second steel plate of the stator in the motor of this embodiment. FIG. 7 is an enlarged view of a part facing the rotor of the stator in the motor of this embodiment. FIG. 8 is a diagram for explaining a preferable slope of the inclined part of the projection part.

As shown in FIG. 4, the stator core 4a of the stator 4 of this embodiment includes a penetrating part 4g that penetrates in the up-and-down direction of the stator 4 and is formed at a location immediately below the fourth flow channel 2i of the housing 2. The penetrating part 4g is disposed, for example, at substantially the center in the right-and-left direction and the front-back direction of the stator 4. In order to form the penetrating part 4g, the first steel plate 4h and the second steel plate 4i are combined and used as the steel plate 4c of the stator core 4a in this embodiment. In this case, additional steel plates may be combined to form the stator core 4a. The arrangement of the through-hole 4g is not particularly limited as long as the through-hole 4g is formed in the stator core 4a.

The first steel plate 4h is formed of a magnetic steel plate, and includes, for example, an annular part 4j, radial parts 4k, and fixed parts 41 as shown in FIG. 5. The annular part 4j is formed into, for example, a substantially annular shape as viewed along the right-and-left direction of the stator 4.

The radial parts 4k constitute the teeth 4e of the stator 4. For example, the width of each of the radial parts 4k gradually increases outward from the center of the annular part 4j as viewed along the right-and-left direction of the stator 4. Tip ends of the radial parts 4k are arranged at intervals from the outer peripheral surface of the rotor 3 in the radial direction of the rotor 3. A bottom part of each of the radial parts 4k is connected to the inner peripheral surface of the annular part 4j. Further, first notch parts 4m for forming the slots 4f between each adjacent pair of the radial parts 4k are provided.

Each fixed part 41 projects outward from the outer peripheral surface of the annular part 4j with respect to the center of the annular part 4j, and is fixed to the housing 2. Each fixed part 41 includes a penetrating part 4n through which, for example, a bolt (not shown) for fixing the stator 4 to the housing 2 penetrates.

As shown in FIG. 6, the second steel plate 4i has substantially the same structure as that of the first steel plate 4h, and thus repeated descriptions are omitted. The second steel plate 4i includes a second notch part 4o for forming the penetrating part 4g. The second notch part 4o is formed so as to penetrate through the annular part 4j and the radial part 4k. One end of the second notch part 4o reaches the tip end of the corresponding radial part 4k, and the other end of the second notch part 4o reaches the outer peripheral surface of the annular part 4j. Further, the second notch part 4o extends in, for example, the up-and-down direction of the stator 4. Instead, the second notch part 4o may he curved, may be formed in a zigzag shape, or may have parts with different widths.

When the second steel plates 4i are stacked to form a part where the penetrating part 4g of the stator core 4a is formed and the first steel plates 4h are stacked to form another part of the stator core 4a, the stator core 4a including the penetrating part 4g as shown in FIG. 4 can be formed. The structure of the stator core 4a allows a part of the coolant supplied from the fourth flow channel 2i of the housing 2 to drop to the penetrating part 4g of the stator core 4a and supplied to the rotor 3 through the penetrating part 4g.

Although not shown, bolts are inserted into the penetrating parts 4n of the fixed parts 41 of the stacked first steel plates 4h and second steel plates 41 and into a fixing jig formed on the housing 2, and nuts are screwed onto the bolts, so that the stator 4 can be fixed to the housing 2. However, the fixing means for fixing the stator 4 to the housing 2 is not limited to the above- mentioned fixing means and any fixing means may be used as long as the stator 4 can be fixed to the housing 2.

In this case, since the rotor 3 is rotated, the air between the rotor 3 and the stator 4 flows along the circumferential direction of the rotor 3. Accordingly, there is a possibility that the coolant supplied to the rotor 3 through the penetrating part 4g of the stator 4 may be scattered by the flow of the air and thus not suitably supplied to the rotor 3. Therefore, the first steel plate 4h and the second steel plate 4i of this embodiment (i.e., the stator 4 of this embodiment) has a structure capable of generating a radial component (a component in the direction of the rotation axis AX1) of the flow of the air between the rotor 3 and the stator 4.

Specifically, as shown in FIG. 7, a tip end (i.e., a tip face of each of the teeth 4e of the stator core 4a) of each of the radial parts 4k of the first steel plate 4h and the second steel plate 4i is provided with a projection part 4p that is formed in such a manner that the interval between the tip end of each radial part 4k and the outer peripheral surface of the rotor 3 gradually decreases in a rotation direction R of the rotor 3. The projection part 4p is disposed in a part or the entire area in the right-and-left direction of the stator 4.

With this structure, the radial component of the rotor 3 is generated in the flow of the air between the rotor 3 and the stator 4, and thus the coolant supplied to the rotor 3 through the penetrating part 4g of the stator core 4a can be suitably supplied to the rotor 3. Accordingly, the motor 1 of this embodiment can be structured to have an excellent capability of cooling the rotor 3. In addition, the coolant is supplied to the inserted part 4d of the stator core 4a by the circumferential component of the rotor 3 in the flow of the air between the rotor 3 and the stator 4, thereby making it possible to suitably cool the stator 4.

As shown in FIG. 7, the projection part 4p may include an inclined part 4g that is inclined in such a manner that, for example, the inclined part 4g gradually approaches the outer peripheral surface of the rotor 3 in the rotation direction R of the rotor 3. With this structure, the radial component of the rotor 3 can be suitably generated in the flow of the air between the rotor 3 and the stator 4, and the air resistance during the rotation of the rotor 3 can be suppressed. Therefore, a decrease in the output of the rotor 3 can be suppressed,

A preferable slope of the inclined part 4q of the projection part 4p will now be considered. For example, as shown in FIG. 8, when the radius of the rotor 3 is represented by “r” and the distance from the rotation axis AX1 of the rotor 3 to the part where the projection part 4P is not formed at the tip face of each of the teeth 4e of the stator core 4a is represented by “r+c”, the inclined part 4q is inclined in such a manner that the inclined part 4q gradually approaches the outer peripheral surface of the rotor 3 in the rotation direction R of the rotor 3 from the intersecting point between the tip face of the tooth 4e and a central line L1 of the tooth 4e. As a coordinate system, xy coordinates with an origin at the rotation axis AX1 of the rotor 3 as shown in FIG. 8 are used.

The equation of the outer periphery of the rotor 3 is represented by the following <Formula 1>.

x²+y²=r² <Formula 1>

The equation of a straight line L2 extending on the inclined part 4q is represented by the throwing <Formula 2>.

y=ax+r+c <Formula 2>

An intersecting point between the straight line L2 and the outer periphery of the rotor 3 is represented by the following <Formula 3>.

x²+(ax+r+c)²=r² <Formula 3>

In order for the straight line L2 to contact the rotor 3 at the above-mentioned intersecting point, the discrimination of the solution to a quadratic equation for x in <Formula 3> satisfies the following <Formula 4>.

{a(r+c)}²−(a²+1){(r+c)²−r²}=0 <Formula 4>

When a slope “a” is calculated from the <Formula 4> to obtain “a=tan θ”, a slope angle θ of the straight line L2 when the straight line L2 contacts the outer periphery of the rotor 3 is obtained.

The value of the slope angle is preferably larger than the slope angle θ of the straight line L2 obtained from <Formula 4> so that the coolant can be actively supplied to the rotor 3. For example, when r=29 mm and c=2 mm, the slope angle θ of the straight line L2 is nearly equal to 28.5 deg. If the slope angle θ has a value larger than such a value, the coolant is more easily supplied to the rotor 3. However, if the value of the slope angle θ of the straight line L2 is extremely large, it is expected that the air resistance during the rotation of the rotor 3 increases. Therefore, the slope angle θ of the straight line L2, i.e., the slope angle θ of the inclined part 4q is preferably in a range from about 30 deg to 45 deg.

Note that the projection part 4p may have such a shape that the differential coefficient of the tip end of the projection part 4p that is located near the rotor 3 is larger than the slope of the tangent to the rotor 3 that passes through the tip end of the projection part 4p and thus the air resistance during the rotation of the rotor 3 can be suppressed. Therefore, the surface of the projection part 4p that faces the rotor 3 may have a curved shape or a step shape. The projection part 4p may be formed in a part or the entire area of the tip face of each of the teeth 4e of the stator core 4a.

In this case, the projection part 4p may he formed of a non-magnetic material. For example, the projection part 4p may have a structure in which the projection part 4p is formed of a non-magnetic material such as austenite and the projection part 4p is formed at the tip face of each of the radial parts 4k of the first steel plate 4h or the second steel plate 4i. With this structure, the magnetic properties of the stator 4 are not changed and thus have no adverse effect on the characteristics of the motor.

Thus, the motor 1 of this embodiment has a structure in which the projection part 4p is provided at the tip face of each of the teeth 4e of the stator core 4a in such a manner that the interval between the tip face of each of the teeth 4e and the outer peripheral surface of the rotor 3 gradually decreases in the rotational direction of the rotor 3. With this structure, the radial component of the rotor 3 can be generated in the flow of the air between the rotor 3 and the stator 4 and the coolant supplied to the rotor 3 through the penetrating part 4g of the stator 4a can be suitably supplied to the rotor 3. Accordingly, the motor 1 of this embodiment can be structured to have an excellent capability of cooling the rotor 3. In particular, since the rotational speed of a motor of a compressor for FC is, for example, 40,000 rpm, an eddy current is generated and thus the motor is more likely to generate heat. Therefore, the motor 1 of this embodiment is suitably used.

The present invention is not limited to the embodiments described above and can be modified as appropriate without departing from the scope of the invention.

For example, when the motor 1 is disposed in a mode in which it is difficult to drop the coolant to the penetrating part 4g of the stator 4, the fourth flow channel 2i of the housing 2 and the penetrating part 42 of the stator 4 may he connected by a connecting pipe. In other words, the motor 1 is not limited to the mode shown in FIG. 1, but instead the motor 1 can he applied to, for example, a mode in which the right-and-left direction shown in FIG. 1 coincides with the vertical direction.

For example, the motor 1 of this embodiment has a structure capable of cooling the stator coil 4b of the stator 4 and the bearings 8. However, these cooling systems may be omitted.

From the invention thus described, it will be obvious that the embodiments of the invention may he varied in many ways. Such variations are not to he regarded as a departure from the spirit and scope of the invention, and all such modifications as would he obvious to one skilled in the art are intended for inclusion within the scope of the following claims.

What is claimed is:

1. A motor comprising:
a rotor having a cylindrical shape; and
a stator disposed so as to surround an outer peripheral surface of the rotor, wherein the stator includes:
a stator core including a plurality of teeth radially arranged about a rotation axis of the rotor; and
a stator coil inserted between each adjacent pair of the teeth,
a flow channel for supplying a coolant to the outer peripheral surface of the rotor is formed within the teeth, and
a projection part is provided at a tip face of each of the teeth facing the outer peripheral surface of the rotor in such a manner that an interval between the tip face of each of the teeth and the outer peripheral surface of the rotor gradually decreases in a rotation direction of the rotor.

2. The motor according to claim 1, wherein the projection part is formed of a non-magnetic material.

3. The motor according to claim 1, wherein the projection part includes an inclined part that is inclined in such a manner that the inclined pall gradually approaches the outer peripheral surface of the rotor in the rotation direction of the rotor.

4. The motor according to claim 1, wherein the motor is a motor of a compressor for a fuel cell.
